(19) United States
(12) Patent Application Publication
(10) Pub. No.: US 2023/0418494 A1
(43) Pub. Date: Dec. 28, 2023

(54) SCALABILITY OF DATA CURSORS IN MEMORY SUBSYSTEMS WHILE REDUCING RESOURCE REQUIREMENTS

(71) Applicant: Micron Technology, Inc., Boise, ID (US)

(72) Inventor: Luca Bert, San Jose, CA (US)

(21) Appl. No.: 17/852,099

(22) Filed: Jun. 28, 2022

(51) Int. Cl. G06F 3/06

(52) U.S. Cl. CPC G06F 3/064; G06F 3/0659; G06F 3/0604; G06F 3/0679

(57) ABSTRACT

A memory subsystem transmits a write granularity parameter that indicates a minimum memory write size of a write command to a host system. A write command is received from the host system, the write command being a size of one or more multiples of the write granularity parameter and the write command identifying one or more logical block addresses using a pointer. Data from the write command is written to a portion of non-volatile memory of the memory subsystem using a first cursor.

### TECHNICAL FIELD

The present disclosure generally relates to memory subsystems, and more specifically, relates to improving the scalability of data cursors while reducing resource requirements.

### BACKGROUND ART

A memory subsystem can include one or more memory devices that store data. The memory devices can be, for example, non-volatile memory devices and volatile memory devices. In general, a host system can utilize a memory subsystem to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory subsystem in accordance with some embodiments of the present disclosure.

FIG. 2 is a flow diagram of an example method to improve the scalability of data cursors in accordance with some embodiments of the present disclosure.

FIG. 3 is an example sequence used to improve the scalability of data cursors in accordance with some embodiments of the present disclosure.

FIG. 4 is a flow diagram of another example method to improve the scalability of data cursors in accordance with some embodiments of the present disclosure.

FIG. 5 is a block diagram of an example computer system in which embodiments of the present disclosure may operate.

### DETAILED DESCRIPTION

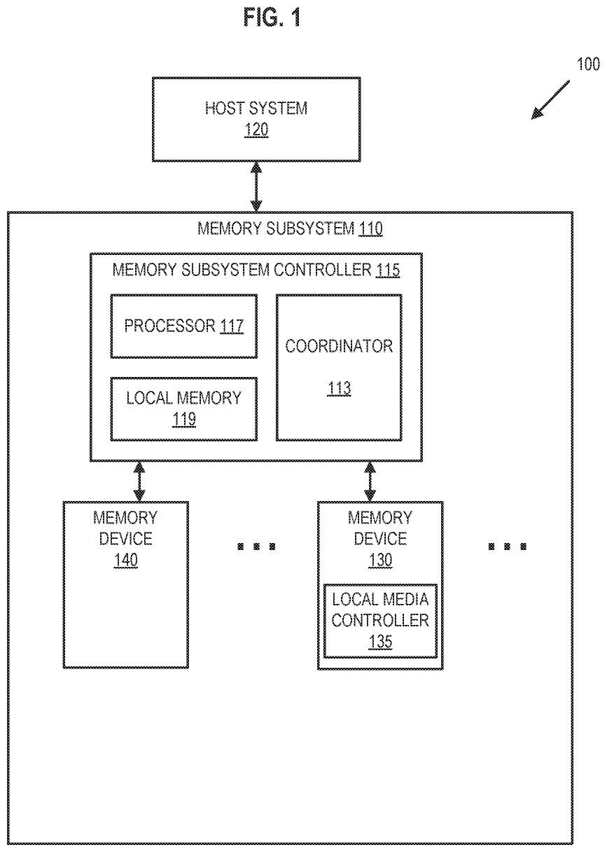

Aspects of the present disclosure are directed to improving the scalability of data cursors in a memory subsystem by utilizing a host system write granularity parameter to increase buffer efficiency. A memory subsystem can be a storage device, a memory module, or a hybrid of a storage device and memory module. Examples of storage devices and memory modules are described below in conjunction with FIG. 1. In general, a host system can utilize a memory subsystem that includes one or more components, such as memory devices that store data. The host system can provide data to be stored at the memory subsystem and can request data to be retrieved from the memory subsystem.

A memory device can be a non-volatile memory device. A non-volatile memory device is a package of one or more dice. One example of non-volatile memory devices is a negative-and (NAND) memory device. Other examples of non-volatile memory devices are described below in conjunction with FIG. 1. The dice in the packages can be assigned to one or more channels for communicating with a memory subsystem controller. Each die can consist of one or more planes. Planes can be grouped into logic units (LUN). For some types of non-volatile memory devices (e.g., NAND memory devices), each plane consists of a set of physical blocks (or pages), which are groups of memory cells to store data. A cell is an electronic circuit that stores information.

Depending on the cell type, a cell can store one or more bits of binary information, and has various logic states that correlate to the number of bits being stored. The logic states can be represented by binary values, such as “0” and “1”, or combinations of such values. There are various types of cells, such as single-level cells (SLCs), multi-level cells (MLCs), triple-level cells (TLCs), and quad-level cells (QLCs). For example, a SLC can store one bit of information and has two logic states.

A host system can issue a write command of a particular size to a memory subsystem that directs the memory subsystem to access a location/address in host memory. The accessed location/address in host memory can contain data to be written into the memory subsystem. It should be appreciated that the memory subsystem can also receive data from the host system in other ways. For ease of description, the present disclosure is written from the perspective of the memory subsystem receiving a write command from the host system.

Generally, write commands indicate a starting logical block address (LBA) and a write length L. The size of the write length L can be 4 KB, for instance. Write commands can be grouped, but these grouped write commands result in sequential LBA addressing. For example, the host system can issue write commands for 64 KB using the write length L of 4 KB (e.g., 16 4 KB write lengths) and starting at LBA0 as Write (LBA=0, L=16).

The memory subsystem transfers the data from the host memory into a buffer in the memory subsystem and, sometime later, programs the buffered data to media (e.g., non-volatile memory or volatile memory with sufficient battery or capacitor power backup to withstand a power failure) along with data from one or more other write commands. In one example, the memory subsystem buffers write commands such that the memory subsystem accumulates a minimum amount of data (e.g., a page size of 288 KB, 384 KB, or another multiple of 4 KB in the hundreds of KB) before the associated data is written as a group to the media. As a result, such a memory subsystem has a significant overprovisioning cost in buffer space to accommodate host system writes of a minimum granularity of 4 KB.

The memory subsystem uses cursors to transfer the buffered data to pages of media responsive to a size of the buffered data being equal to a size of the page (or a multiple thereof). Accordingly, the larger the page size, the more data that should be buffered/accumulated before being transferred to the media. Moreover, some cursors can write to blocks (e.g., groups of pages), which increases the data that is buffered before being transferred to the media. Increasing the buffered data using non-volatile memory increases the power consumed by the memory subsystem.

Memory subsystems are capable of writing to/reading from (hereinafter referred to as “operating on”) media (e.g., non-volatile memory devices) using multiple data cursors in parallel. Operating on media using parallel data cursors allows at least for (1) data separation and (2) improved efficiency. For example, a data of one type/classification can be written to media using a first cursor, and a data of a second type/classification may be written to the media using a second cursor. Data that is separated (using multiple cursors for instance) can be easier to manage. The scalability of parallel cursors (i.e., the number of cursors used in parallel), however, is limited due, in part, to the size of the pages of the media and serialization constraints. To keep data separate, each cursor should be associated with its own buffered data. Accordingly, the buffer capacity requirements and power requirements scale directly with the number of cursors. The more cursors that are utilized by the memory subsystem, the greater the overprovisioning penalty to allow the memory subsystem to buffer the data.

Aspects of the present disclosure address the above and other deficiencies by reducing the need to buffer write commands by indicating, to the host system(s) writing to a memory subsystem, a size of the portion of memory to which each cursor writes (e.g., a host write granularity corresponding to the cursor write size which is the page size of the media written to by the cursor). In response, the host issues write commands that align with the cursor write size. For example, the host can issue write commands the size of the page (or a multiple thereof). The host can also use a group write structure, grouping smaller write commands such that the size of the grouped commands is the size of the page (or a multiple thereof).

If the host issues write command using the group write structure, the memory subsystem extracts/processes write data from the group write structure resulting in received write data at the memory subsystem at least a size of the page (or a multiple thereof). As a result, the memory subsystem reduces the need to buffer write commands in non-volatile memory before programming the data to media, reducing the resource requirements of the memory subsystem. For example, reducing the need to buffer write commands in non-volatile memory: (1) conserves power (e.g., there is a reduced need to support non-volatile memory for buffering write data received from the host); (2) facilitates data separation (e.g., the memory subsystem can utilize one or more data cursors to program media before data is comingled in non-volatile memory); and (3) facilitates increasing the number of parallel data cursors without overprovisioning penalties (e.g., the memory subsystem does not need to support the operation of each cursor with non-volatile memory buffers).

Because the memory subsystem receives write commands in multiples of the memory subsystem write granularity (e.g., by receiving grouped write commands using the group write structure or by receiving singular write commands at least the size of the page of media), write commands can be buffered briefly in volatile memory (as opposed to non-volatile memory). Buffering the write commands briefly in volatile memory before programming the data to media reduces the resource requirements of the memory subsystem. For example, buffering write commands in volatile memory, as compared to non-volatile memory, reduces power/capacity resources consumed by the memory subsystem. Moreover, buffering write commands in volatile memory can reduce the cost of memory subsystems as volatile memory is generally less expensive than non-volatile memory. Given the reduction in the resource requirements, the memory subsystem is able to provide a greater scalability of write cursors.

FIG. 1 illustrates an example computing system 100 that includes a memory subsystem 110 in accordance with some embodiments of the present disclosure. The memory subsystem 110 can include media, such as one or more volatile memory devices (e.g., memory device 140), one or more non-volatile memory devices (e.g., memory device 130), or a combination of such.

A memory subsystem 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory subsystems 110. In some embodiments, the host system 120 is coupled to different types of memory subsystems 110. FIG. 1 illustrates one example of a host system 120 coupled to one memory subsystem 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory subsystem 110, for example, to write data to the memory subsystem 110 and read data from the memory subsystem 110.

The host system 120 can be coupled to the memory subsystem 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), Small Computer System Interface (SCSI), a double data rate (DDR) memory bus, a dual in-line memory module (DIMM) interface (e.g., DIMM socket interface that supports Double Data Rate (DDR)), Open NAND Flash Interface (ONFI), Double Data Rate (DDR), Low Power Double Data Rate (LPDDR), or any other interface. The physical host interface can be used to transmit data between the host system 120 and the memory subsystem 110. The host system 120 can further utilize an NVM Express (NVMe) interface to access components (e.g., memory devices 130) when the memory subsystem 110 is coupled with the host system 120 by the PCIe interface. The physical host interface can provide an interface for passing control, address, data, and other signals between the memory subsystem 110 and the host system 120. FIG. 1 illustrates a memory subsystem 110 as an example. In general, the host system 120 can access multiple memory subsystems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include negative-and (NAND) type flash memory and write-in-place memory, such as a three-dimensional cross-point (“3D cross-point”) memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Although non-volatile memory devices such as NAND type memory (e.g., 2D NAND, 3D NAND) and 3D cross-point array of non-volatile memory cells are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory subsystem controller 115 (or controller 115 for simplicity) can communicate with the memory devices 130 to perform operations such as reading data, writing data, or erasing data at the memory devices 130 and other such operations (e.g., in response to commands scheduled on a command bus by controller 115). The memory subsystem controller 115 can include hardware such as one or more integrated circuits and/or discrete components, a buffer memory, or a combination thereof. The hardware can include digital circuitry with dedicated (i.e., hard-coded) logic to perform the operations described herein. The memory subsystem controller 115 can be a microcontroller, special purpose logic circuitry (e.g., a field programmable gate array (FPGA), an application specific integrated circuit (ASIC), etc.), or another suitable processor.

The memory subsystem controller 115 can include a processing device 117 (processor) configured to execute instructions stored in a local memory 119. In the illustrated example, the local memory 119 of the memory subsystem controller 115 includes an embedded memory configured to store instructions for performing various processes, operations, logic flows, and routines that control operation of the memory subsystem 110, including handling communications between the memory subsystem 110 and the host system 120.

In some embodiments, the local memory 119 can include memory registers storing memory pointers, fetched data, etc. The local memory 119 can also include read-only memory (ROM) for storing micro-code. While the example memory subsystem 110 in FIG. 1 has been illustrated as including the memory subsystem controller 115, in another embodiment of the present disclosure, a memory subsystem 110 does not include a memory subsystem controller 115, and can instead rely upon external control (e.g., provided by an external host, or by a processor or controller separate from the memory subsystem 110).

In general, the memory subsystem controller 115 can receive commands or operations from the host system 120 and can convert the commands or operations into instructions or appropriate commands to achieve the desired access to the memory devices 130 and/or the memory device 140. The memory subsystem controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 130. The memory subsystem controller 115 can further include host interface circuitry to communicate with the host system 120 via the physical host interface. The host interface circuitry can convert the commands received from the host system into command instructions to access the memory devices 130 and/or the memory device 140 as well as convert responses associated with the memory devices 130 and/or the memory device 140 into information for the host system 120.

The memory subsystem 110 can also include additional circuitry or components that are not illustrated. In some embodiments, the memory subsystem 110 can include a cache or buffer (e.g., DRAM) and address circuitry (e.g., a row decoder and a column decoder) that can receive an address from the memory subsystem controller 115 and decode the address to access the memory devices 130.

In some embodiments, the memory devices 130 include local media controllers 135 that operate in conjunction with memory subsystem controller 115 to execute operations on one or more memory cells of the memory devices 130. An external controller (e.g., memory subsystem controller 115) can externally manage the memory device 130 (e.g., perform media management operations on the memory device 130). In some embodiments, a memory device 130 is a managed memory device, which is a raw memory device combined with a local controller (e.g., local controller 135) for media management within the same memory device package. An example of a managed memory device is a managed NAND (MNAND) device.

The memory subsystem 110 includes a coordinator component 113 that reduces the need to buffer write commands directed to the memory devices 130. In some embodiments, the controller 115 includes at least a portion of the coordinator component 113. For example, the controller 115 can include a processor 117 (processing device) configured to execute instructions stored in local memory 119 for performing the operations described herein. In some embodiments, a coordinator component 113 is part of the host system 120, an application, or an operating system.

The coordinator component 113 indicates a write granularity parameter to the host system 120. As described herein, the write granularity parameter is a size of write data the memory subsystem 110 will accept from the host system 120. That is, the write granularity is, a minimum logical block size/length of a write command, which is determined by the coordinator component 113 according to a minimum size of the page of media (e.g., memory device 130). The coordinator component 113 can also utilize a new write command data structure that allows the coordinator component 113 to extract write data from a list of LBAs. In one embodiment, the indication of write granularity and the write command data structure are improvements to or otherwise additions to an access protocol, such as NVMe. Further details with regards to the operations of the coordinator component 113 are described below.

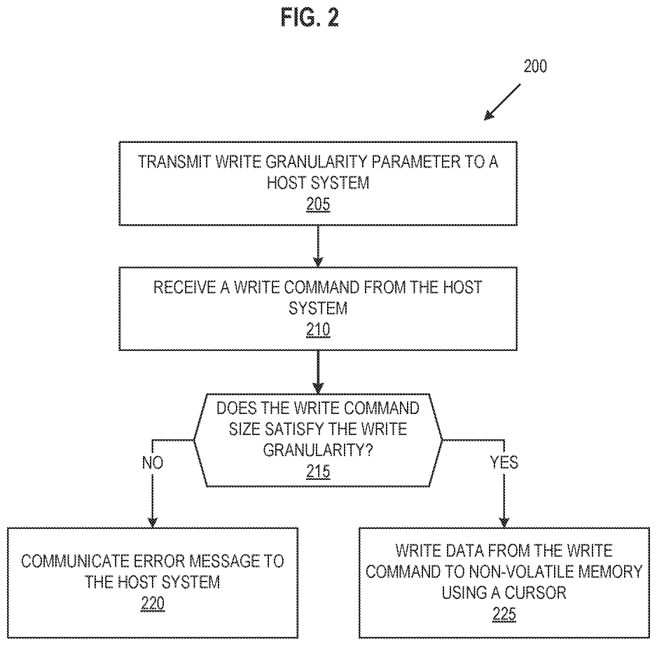

FIG. 2 is a flow diagram of an example method 200, in accordance with some embodiments of the present disclosure. The method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 200 is performed by the coordinator component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 205, coordinator component 113 transmits a write granularity parameter to a host system 120. The write granularity parameter is a parameter indicating a minimum memory write size the memory subsystem 110 will accept from the host system 120 (e.g., a minimum logical block size/length of a write command and/or a minimum size of the page of media). For example, the coordinator component 113 can transmit the write granularity within a byte range of a data structure that indicates capabilities and settings of at least a portion of the memory subsystem 110 and is sent to the host system 120 as a part of the NVMe or similar protocol. Different portions of media can have unique page sizes. Accordingly, the coordinator component 113 of the memory subsystem 110 can transmit, to the host system 120, a write granularity corresponding to the unique page size of a particular portion of media of the memory subsystem 110, such as a namespace, die, or other physical/logical subdivision of memory.

In some implementations, the host system 120 queries the coordinator component 113 for the write granularity parameter. In response to the query from the host system 120, the coordinator component 113 of the memory subsystem 110 can transmit the write granularity parameter. In other implementations, the coordinator component 113 can transmit the write granularity parameter given a triggering condition (e.g., at boot time). It should be appreciated that operation 205 can be performed once (e.g., at boot time) and operations 210-215 can be performed recursively (e.g., each time a write command is received).

At operation 210, the coordinator component 113 receives a write command from the host system 120. For example, the host system 120 can issue a write command that identifies data to be written to the portion of the memory subsystem 110 as described above. In some embodiments, the write command is received by the coordinator component 113 as a standard write command (e.g., indicating an address and length using {Starting LBA, Length}, where Length is a whole number multiple of the write granularity). In other embodiments, the write command is received by the coordinator component 113 in a group write structure. For example, using the group write structure, the host system 120 can issue the write command using a pointer to a list of N entries. Each entry in the list can indicate an address using a starting LBA and a write length L. Each entry in the list can have the same write length L, different write length L, or some combination. For example, in the group write structure, each write length L can be less than, equal to, or greater than the write granularity while the sum of all write lengths L in the group write structure collectively satisfy the write granularity (or a multiple thereof).

The coordinator component 113 can receive/process write data from non-contiguous LBAs responsive to the host system 120 addressing LBAs using the list and pointer identified in the group write structure. For example, given three LBAs in sequence, the pointer can point to a list including the first LBA and the third LBA (non-contiguous LBAs) and corresponding lengths that do not bridge the gap between the first and third LBA.

The host system 120 can create the group write structure by buffering multiple write commands and corresponding write data until the buffered data reaches the size of the write granularity parameter. In response to the size of the buffered write commands being equal to the size of the write granularity parameter (or a multiple thereof), the host system 120 can issue the grouped write commands to the coordinator component 113 via the group write structure. The group write structure allows the host system 120 to accumulate (or group) write commands and communicate a single group write command to the coordinator component 113 the size of the write granularity parameter (or a multiple thereof).

The coordinator component 113 receives the group write structure the size of the write granularity parameter (or a multiple thereof) and extracts write data from one or more LBAs using the pointer and list of the group write structure. Instead of buffering write data in non-volatile memory until write data at least the size of the write granularity parameter is accumulated by the coordinator component 113, the coordinator component 113 receives write data at least the size of a page of media and can instruct the cursor to write the received write data to the media (e.g., the memory device 130).

Implementing the multiple writes (e.g., using the pointer/list mechanism) and buffering the multiple writes in the host system 120 beneficially reduces the need for the memory subsystem 110 to buffer write data extracted from write commands. The host system 120 is advantageously configured to buffer the list in host memory because, generally, host systems have more volatile memory (e.g., DRAM) than memory subsystems. Moreover, memory subsystems 110 generally store committed data (e.g., data that must survive power failures) and host systems 120 generally store uncommitted data (e.g., data that does not need to survive power failures). Accordingly, the host system 120 is not overburdened by buffering multiple writes in non-volatile memory, reducing the overprovisioning penalty and power resources associated with buffering such data in the memory subsystem 110.

In a non-limiting example, a host system 120 can issue a group write command for a write granularity of 64 KB using a host write length of 4 KB to even numbered LBAs using the group write structure. The coordinator component 113 can receive GroupWrite (LBA_pointer) where LBA_pointer points to entries in a list such as {LBA=0, L=1; LBA=2, L=1; LBA=4, L=1 . . . LBA=30, L=1}. In some embodiments, the coordinator component 113 is configured to navigate, using the pointer, to a list in the host memory indicating the LBAs in the host memory that contain the data to be written by the coordinator component 113 to the media (e.g., memory device 130). In other embodiments, the coordinator component 113 can receive the list of LBA entries and/or the write data using the group write structure.

In another non-limiting example, a host system 120 can issue a group write command using the group write structure for the write granularity of 64 KB using the host write length of 4 KB. The coordinator component 113 can receive GroupWrite (LBA_pointer) where LBA_pointer points to entries in a list such as {LBA=0, L=2; LBA=2, L=1; LBA=10, L=5; LBA=5, L=2; LBA=50, L=3; LBA=30, L=3}. As shown, the group write structure can include segments of various write lengths L with a cumulative length of the write granularity or multiple thereof. Moreover, the group write structure can be used to point to LBAs that are not sequential.

In some embodiments, the coordinator component 113 allocates and fills volatile memory (e.g., memory device 140, local memory 119) with the data identified via the group write structure. For example, the coordinator component 113 can allocate and fill a portion of a transient buffer with write data before the write data is transferred to (written to) non-volatile data (e.g., memory device 130). An example transient buffer includes a “Just-in-Time” buffer. The size of the allocated transient buffer can be equal to the size of the write granularity parameter (or a multiple thereof).

At operation 215, the coordinator component 113 determines if the size of the received write command satisfies the write granularity parameter (e.g., is equal to the granularity parameter or a multiple thereof). For example, if the size of the received write command is equal to 32 KB and the write granularity parameter is equal to 16 KB, then the coordinator component 113 determines that the size of the received write command, as a whole number multiple of the write granularity parameter, satisfies the write granularity parameter. If the coordinator component 113 determines that the size of the received write command satisfies the write granularity parameter, the method 200 continues to operation 225. If the coordinator component 113 determines that the size of the received write command does not satisfy the write granularity parameter, the method 200 continues to operation 220.

In operation 220, the coordinator component 113 communicates (e.g., returns/transmits) an error message/bit/flag or other indicator responsive to the size of the write command not satisfying the write granularity parameter. The coordinator component 113 rejects the received write command (from operation 210) because the coordinator component 113 is not configured to store/buffer portions of write data in non-volatile memory buffers that do not align with the write granularity.

At operation 225, the coordinator component 113 writes data from the write command to a portion of non-volatile memory (e.g., media) using a cursor. The coordinator component 113 can be configured to use multiple cursors to write to different portions of the non-volatile memory, similar portions of the non-volatile memory, or different non-volatile memory (or some combination) simultaneously (e.g., in parallel, near real-time). For example, the coordinator component 113 can use a different cursor to write each of multiple write commands.

In a non-limiting example, the coordinator component 113 can receive a first write command and a second write command from a host system 120 using two different group write structures (e.g., a first group write structure utilizing a pointer to a first set of LBAs, and a second group write structure utilizing a different pointer to a different set of LBAs). The first and second write commands may contain different types of data. In response to determining, by the coordinator component 113, that the size of the data associated with each group write structure satisfies the write granularity parameter (e.g., as described with reference to operation 215), the coordinator component 113 can write data from both write commands to portions of the non-volatile memory using multiple cursors. The writes to the non-volatile memory using the multiple cursors can occur in parallel.

It should be appreciated that while method 200 describes an embodiment in which cursor scalability is improved in the memory subsystem 110 by increasing buffer efficiency (e.g., by reducing the need for buffers generally and/or allowing the use of volatile buffers instead of non-volatile buffers), the host system 120 may communicate, to the memory subsystem 110, that the host system 120 does not intend to capitalize on such advantages (or implement such features as the write granularity parameter and/or group write structure). For example, the host system 120 may not be configured to generate group write structures, the host system 120 may not have memory capacity and/or power capacity to buffer write data in a list, etc. As such, an embodiment of the coordinator component 113 can be configured to allocate and fill write buffers with data identified with the write command using non-volatile memory. For example, in response to accumulating a size of write data (e.g., the size of the write data being equal to the write granularity parameter) in the memory subsystem 110 (e.g., in a buffer), a cursor can transfer the contents of the buffer to the media. (e.g., non-volatile memory, memory device 140). That is, the coordinator component 113 can be backwards compatible and can use conventional mechanisms of writing data to the media. The coordinator component 113 can determine whether to execute method 200 responsive to receiving, from the host system 120, an indication that the host system 120 intends to utilize the write granularity parameter and/or group write structure. For example, the host system 120 can flag/set one or more bits in one or more data packets of the NVMe or similar protocol in response to operation 205.

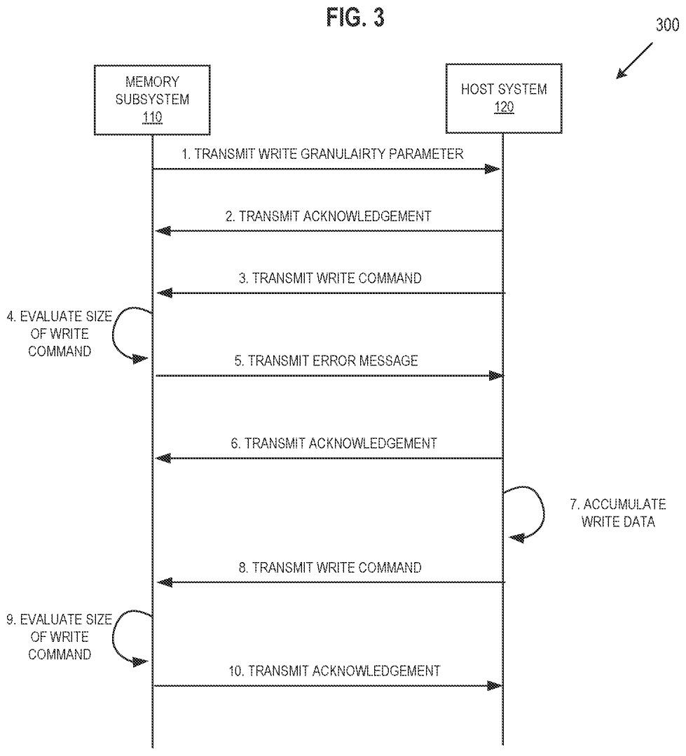

FIG. 3 is an example sequence diagram of an example sequence 300 used to improve the scalability of data cursors in accordance with some embodiments of the present disclosure. The sequence is shown between a memory subsystem 110 (e.g., including a coordinator component 113 of FIG. 1) and a host system 120. In other illustrative sequences, the memory subsystem 110 may communicate with multiple host systems. Accordingly, the processes and communications performed by the memory subsystem 110 may be performed in parallel.

At a time indicated by numeral 1, the memory subsystem 110 transmits a write granularity parameter to the host system 120. The write granularity parameter is a minimum logical block size/length of a write command, which is determined by the memory subsystem 110 according to a minimum size of the page of media (e.g., memory device 130). As illustrated, the memory subsystem 110 transmits the write granularity parameter to the host system 120 only once during the sequence (e.g., at boot time). In some implementations, the memory subsystem 300 may transmit the write granularity parameter to the host system 120 at other times (e.g., upon receiving a request from the host system 120, upon rejecting a write command from the host system 120).

At a time indicated by numeral 2, the host system 120 optionally transmits an acknowledgement to the memory subsystem 110. The acknowledgement indicates that that host system 120 has confirmed receipt of the write granularity parameter and/or that the host system 120 has stored the write granularity parameter in host memory. As described herein, if the host system 120 transmits a write command that is not the size of the write granularity parameter, the memory subsystem 110 will return an error. As such, in some embodiments, the memory subsystem 110 may request an acknowledgement in response to transmitting the write granularity parameter at numeral 1. In some embodiments, the acknowledgement indicated by numeral 2 is not needed.

At a time indicated by numeral 3, the host system 120 transmits a write command to the memory subsystem 110. The write command may be a group write command (e.g., implemented via the group write structure) and/or a standard write command. For example, the standard write command can indicate an address and length of write data using {Starting LBA, Length}, and the group write structure can indicate write commands using a pointer to a list of N entries. As described herein, each entry in the list can indicate an address of the write data using a starting LBA and a write length.

During a time period indicated by numeral 4, the memory subsystem 110 evaluates whether the size of the write data associated with the received write command from the host system 120 (at numeral 3) satisfies the size of the write granularity parameter. If the received write command is in a group write structure, the memory subsystem 110 extracts write data corresponding to the write command by navigating, using the pointer of the group write structure, to the list in host memory of the host system 120 indicating the LBAs in the host memory that contain the write data. Additionally or alternatively, the memory subsystem 110 can extract write data corresponding to the write command responsive to receiving the list of LBA entries and/or the write data. The memory subsystem 110 may compare the byte size of the extracted write data to the byte size identified by the write granularity parameter to evaluate whether the size of the write data satisfies the size of the write granularity parameter.

As illustrated, at a time indicated by numeral 5, the memory subsystem 110 transmits an error message (or other bit/flag/indication) to the host system 120 responsive to the size of the write data of the write command not satisfying the size of the write granularity parameter. The error message indicates that the memory subsystem 110 is rejecting the entirety of the write command (e.g., the memory subsystem 110 is not storing/buffering portions of write data in non-volatile memory buffers).

At a time indicated by numeral 6, the host system 120 optionally transmits an acknowledgement to the memory subsystem 110 responsive to receipt of the error message. The acknowledgement indicates that the host system 120 should retransmit the write command (transmitted at numeral 3) in addition to other write commands to increase the size of the transmitted write data. In some embodiments, the acknowledgement indicated by numeral 6 is not needed.

During a time period indicated by numeral 7, the host system 120 accumulates write data, buffering the multiple writes in the host system 120 until the byte size of the write data is a whole number multiple of the byte size of the write granularity parameter.

At a time indicated by numeral 8, the host system 120 transmits a write command to the memory subsystem 110. As described herein, the write command may be a group write command (e.g., implemented via the group write structure) and/or a standard write command. In some embodiments, the write command includes at least the write data associated with the write command at numeral 3.

During a time period indicated by numeral 9, the memory subsystem 110 evaluates whether the size of the write data associated with the received write command from the host system 120 (at numeral 8) satisfies the size of the write granularity parameter. As described herein, the memory subsystem 110 may compare the byte size of the write data of the write command to the byte size identified by the write granularity parameter.

At a time indicated by numeral 10, the memory subsystem 110 transmits an acknowledgement to the host system 120. In some embodiments, the memory subsystem 110 transmits the acknowledgement responsive to determining that the write data associated with the transmitted write command (at numeral 8) satisfies the size of the write granularity parameter. In other embodiments, the memory subsystem 110 transmits the acknowledgement responsive to buffering the write data associated with the transmitted write command (at numeral 8) in a transient buffer. The memory subsystem 110 only buffers the write data in a transient buffer responsive to determining that the write data satisfies the size of the write granularity parameter. In some implementations, the memory subsystem 110 does not buffer the write data in a transient buffer. In yet other embodiments, the memory subsystem 110 transmits the acknowledgement responsive to transferring the write data to media of the memory subsystem 110. That is, the cursor writes the write data to a page of the media of the memory subsystem 110. In some embodiments, the acknowledgement indicated by numeral 10 is not needed.

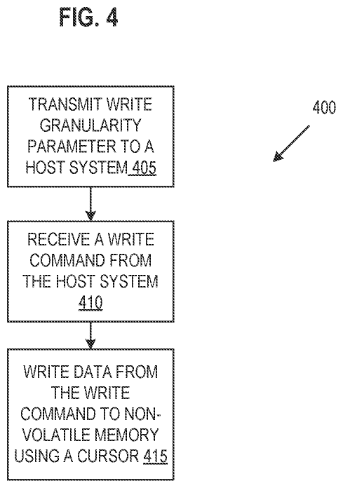

FIG. 4 is a flow diagram of another example method 400 to improve the scalability of data cursors, in accordance with some embodiments of the present disclosure. The method 400 can be performed by processing logic that can include hardware (e.g., coordinator component 113, circuitry, dedicated logic, programmable logic, microcode, hardware of a device, integrated circuit, etc.), software (e.g., instructions run or executed on a coordinator component 113), or a combination thereof. In some embodiments, the method 400 is performed by the coordinator component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 405, the coordinator component 113 transmits a write granularity parameter to a host system 120. The write granularity parameter is a parameter indicating a minimum memory write size the memory subsystem 110 will accept from the host system 120. That is, the write granularity is a minimum logical block size/length of a write command which is determined by the coordinator component 113 according to a minimum size of the page of media (e.g., memory device 130). For example, the coordinator component 113 can transmit the write granularity within a byte range of a data structure that indicates capabilities and settings of at least a portion of the memory subsystem 110 and is sent to the host system 120 as a part of the NVMe or similar protocol. Different portions of media can have unique page sizes. Accordingly, the coordinator component 113 can transmit, to the host system 120, a write granularity corresponding to the unique page size of a particular portion of media, such as a namespace, die, or other physical/logical subdivision of memory.

In some implementations, the host system 120 queries the coordinator component 113 for the write granularity parameter. In response to the query from the host system 120, the coordinator component 113 of the memory subsystem 110 can transmit the write granularity parameter. In other implementations, the coordinator component 113 can transmit the write granularity parameter given a triggering condition (e.g., at boot time). It should be appreciated that the coordinator component 113 can perform operation 405 once (e.g., at boot time) and operations 410-415 can be performed by the coordinator component 113 recursively (e.g., each time a write command is received).

At operation 410, the coordinator component 113 receives a write command from the host system 120. As described in operation 210 with reference to FIG. 2, the coordinator component 113 can receive the write command as a standard write command (e.g., indicating an address and length using {Starting LBA, Length}, where Length is whole number multiple of the write granularity). The coordinator component 113 can also receive the write command in the form of a group write structure allowing the coordinator component 113 to extract write data from one or more LBAs of the host system 120 using the pointer and list of the group write structure, as described herein. The flow of operations moves to operation 415.

At operation 415, the coordinator component 113 writes data from the write command to a portion of non-volatile memory using a cursor. The coordinator component 113 can be configured to use multiple cursors to write to different portions of the non-volatile memory, similar portions of the non-volatile memory, or different non-volatile memory (or some combination) simultaneously (e.g., in parallel, near real-time). For example, the coordinator component 113 can use a different cursor to write each of multiple write commands.

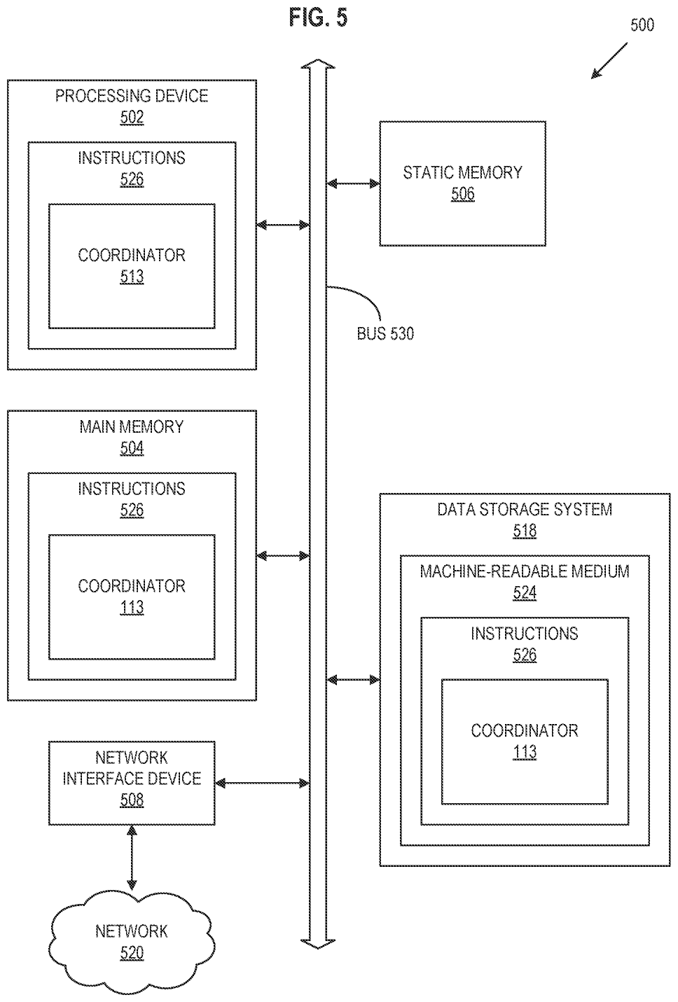

FIG. 5 illustrates an example machine of a computer system 500 within which a set of instructions, for causing the machine to perform any one or more of the methodologies discussed herein, can be executed. In some embodiments, the computer system 500 can correspond to a host system (e.g., the host system 120 of FIG. 1) that includes, is coupled to, or utilizes a memory subsystem (e.g., the memory subsystem 110 of FIG. 1) or can be used to perform the operations of a controller (e.g., to execute an operating system to perform operations corresponding to the coordinator component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory subsystem 110 of FIG. 1.

In one embodiment, the instructions 526 include instructions to implement functionality corresponding to a coordinator component (e.g., the coordinator component 113 of FIG. 1). While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially structured for the intended purposes, or it can include a general-purpose computer selectively activated or reconfigured by a computer program stored in the computer. For example, a computer system or other data processing system, such as the coordinator component 113, may carry out the computer-implemented method 200 in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to structure a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising:
transmitting a write granularity parameter to a host system, the write granularity parameter indicating a minimum memory write size of a write command;
receiving, from the host system, a first write command of a size of one or more multiples of the write granularity parameter, the first write command identifying one or more logical block addresses using a pointer; and
writing data from the first write command to a portion of non-volatile memory of a memory subsystem using a first cursor.

2. The method of claim 1, further comprising:
writing data from the first write command to a portion of volatile memory.

3. The method of claim 1, wherein the pointer points to a list having multiple entries, each entry in the list indicating a starting logical block address and a write length.

4. The method of claim 1, wherein:
the one or more logical block addresses comprise a first logical block address, a second logical block address, and a third logical block address in sequence; and
the pointer points to the first logical block address and the third logical block address, the first and third logical block addresses being non-contiguous.

5. The method of claim 1, further comprising:
receiving, a second write command according to the write granularity parameter, the second write command identifying another one or more logical block addresses using another pointer; and
writing data from the second write command to another portion of non-volatile memory using a second cursor.

6. The method of claim 5, wherein the writing the first write command to a portion of non-volatile memory using the first cursor occurs in parallel with the writing the second write command to another portion of non-volatile memory using the second cursor.

7. The method of claim 1, further comprising:
receiving a second write command;
determining that the second write command is a size not according to the write granularity parameter; and
communicating an error message responsive to the second write command being the size not according to the write granularity parameter.

8. A non-transitory computer-readable storage medium comprising instructions that, when executed by a processing device, cause the processing device to:
transmit a write granularity parameter to a host system, the write granularity parameter indicating a minimum memory write size of a write command;
receive, from the host system, a first write command of a size of one or more multiples of the write granularity parameter, the first write command identifying one or more logical block addresses using a pointer; and
write data from the first write command to a portion of non-volatile memory of a memory subsystem using a first cursor.

9. The non-transitory computer-readable storage medium of claim 8, wherein the processing device is further to:
write data from the first write command to a portion of volatile memory.

10. The non-transitory computer-readable storage medium of claim 8, wherein the pointer points to a list having multiple entries, each entry in the list indicating a starting logical block address and a write length.

11. The non-transitory computer-readable storage medium of claim 8, wherein:
the one or more logical block addresses comprise a first logical block address, a second logical block address, and a third logical block address in sequence; and
the pointer points to the first logical block address and the third logical block address, the first and third logical block addresses being non-contiguous.

12. The non-transitory computer-readable storage medium of claim 8, wherein the processing device is further to:
receive a second write command according to the write granularity parameter, the second write command identifying another one or more logical block addresses using another pointer; and
write data from the second write command to another portion of non-volatile memory using a second cursor.

13. The non-transitory computer-readable storage medium of claim 12, wherein the writing the first write command to a portion of non-volatile memory using the first cursor occurs in parallel with writing the second write command to another portion of non-volatile memory using the second cursor.

14. The non-transitory computer-readable storage medium of claim 8, wherein the processing device is further to:
receive a second write command;
determine that the second write command is a size not according to the write granularity parameter; and
communicate an error message responsive to the second write command being the size not according to the write granularity parameter.

15. A system comprising:
a memory component; and
a processing device, coupled to the memory component, configured to:
transmit a write granularity parameter to a host system, the write granularity parameter indicating a minimum memory write size of a write command;
receive, from the host system, a first write command of a size of one or more multiples of the write granularity parameter, the first write command identifying one or more logical block addresses using a pointer pointing to a list having multiple entries, each entry in the list indicating a starting logical block address and a write length; and
write data from the first write command to a portion of non-volatile memory of a memory subsystem using a first cursor.

16. The system of claim 15, wherein the processing device is further to:
write data from the first write command to a portion of volatile memory.

17. The system of claim 15, wherein:
the one or more logical block addresses comprise a first logical block address, a second logical block address, and a third logical block address in sequence; and
the pointer points to the first logical block address and the third logical block address, the first and third logical block addresses being non-contiguous.

18. The system of claim 15, wherein the processing device is further to:
receive a second write command according to the write granularity parameter, the second write command identifying another one or more logical block addresses using another pointer; and
write data from the second write command to another portion of non-volatile memory using a second cursor.

19. The system of claim 18, wherein the writing the first write command to a portion of non-volatile memory using the first cursor occurs in parallel with writing the second write command to another portion of non-volatile memory using the second cursor.

20. The system of claim 15, wherein the processing device is further to:
receive a second write command;
determine that the second write command is a size not according to the write granularity parameter; and
communicate an error message responsive to the second write command being the size not according to the write granularity parameter.
